(19) United States
(12) Patent Application Publication
(10) Pub. No.: US 2021/0224434 A1
(43) Pub. Date: Jul. 22, 2021

(54) SERVICE LINE-BASED PREDICATION METHOD, DEVICE, STORAGE MEDIUM AND TERMINAL

(71) Applicant: PING AN TECHNOLOGY (SHENZHEN) CO., LTD., Shenzhen, Guangdong (CN)

(72) Inventor: Xiaohui WAN, Shenzhen (CN)

(73) Assignee: Ping An Technology (Shenzhen) Co., Ltd., Shenzhen, Guangdong (CN)

(21) Appl. No.: 16/093,628

(22) PCT Filed: Feb. 27, 2018
(86) PCT No.: PCT/CN2018/077347

§ 371 Date: Oct. 13, 2018

(30) Foreign Application Priority Data
Jul. 26, 2017 (CN) 201710615821.X

(51) Int. Cl. G06F 30/20; G06F 16/28; G06Q 10/06

(52) U.S. Cl. CPC G06F 30/20; G06F 16/283; G06F 2111/08; G06Q 10/06398; G06Q 10/06315

(57) ABSTRACT

A service line-based predication method and device, a storage medium and a terminal are provided. The method includes: when service predication is performed on a specified service line, acquiring a predication model corresponding to this specified service line, and input dimensions and output dimensions of this predication; acquiring predication data satisfying the input dimensions from a data warehouse; performing trend analysis on the predication data adopting Monte Carlo simulation and geometric Brownian motion through the predication model to obtain the predication values of the output dimensions; and calculating total task amount and manpower quantity required to be input of the specified service line within a specified period of time according to the predication values. The predication model is divided into an incoming call predication model and a calling predication model according to service types. The present disclosure realizes that different predication modes are adopted aiming at different service scenes.

This application claims priority to Chinese Patent Application No. 201710615821.X with a filing date of Jul. 26, 2017, entitled “Service Line-Based Predication Method and Device, Storage Medium and Terminal”.

### TECHNICAL FIELD

The present disclosure relates to the technical field of communication, and more particularly to a service line-based predication method and device, a storage medium and a terminal.

### BACKGROUND OF THE PRESENT INVENTION

For scheduling of incoming call services and calling services, the existing techniques mainly adopt a time series predication method, a regression prediction model and other predication modes to perform scheduling predication. The time series predication method is a history resource extending predication which can perform extension and extrapolation based on a development process and rules reflected by time series to predict a development trend. The regression prediction model refers to establishing a regression equation between variables by analyzing correlativity between an independent variable and a dependent variable on the market so as to use the regression equation as, a predication model. However, the calling service mainly stresses the amount of the called customers, and, meanwhile involves, a call completion rate of a customer list and, purchasing desire of a customer on a product; the incoming call service mainly stresses call durations and call times, thus different service types involve different call durations and call times. The existing techniques adopt a unified predication mode aiming at different service scenes, which are low in accuracy of scheduling predication and difficultly satisfy the increasing complex demand on the market.

### SUMMARY OF PRESENT INVENTION

Embodiments of the present disclosure provide a service line-based predication method and device, a storage medium and a terminal. The predication method includes: when service predication is performed on a specified service line, acquiring a predication model corresponding to this specified service line, and input dimensions and output dimensions of this prediction; acquiring predication data, satisfying the input dimensions from a data warehouse; performing trend analysis on the predication data adopting Monte Carlo simulation and geometric Brownian motion through the predication model to obtain predication values of the output dimensions; and calculating total task amount and manpower quantity required to be input of the specified service line within a specified period of time according to the predication values; wherein, the predication model is divided into an incoming call predication model and a calling predication model according to service types, and the data warehouse is composed of call data and dialing list data within preset historical time after cleaning.

Advantageously, after the predication values of the output dimensions are obtained, the predication method also includes: acquiring marketing activities and emergent events within the preset historical time, and determining dates of a week when the marketing activities and the emergent events occur; and performing smoothing processing on the predication values of the output dimensions according to the dates of a week of the marketing activities and the emergent events to eliminate the interference of the marketing activities and the emergent, events on the predication values.

Advantageously, the performing smoothing processing on the predication values of the output dimensions according to the dates of a week of the marketing activities and the emergent events to eliminate the interference of the marketing activities and the emergent events on the predication values includes: traversing all the output dimensions, and screening predication values having the same dates of a week from the predication values of the output dimensions to serve as base data; calculating an average value and a standard deviation of the base data; calculating a difference between each base data and the average value, and comparing an absolute value of the difference with the standard deviation; and when the absolute value of the difference is greater than the standard deviation, reducing the base data corresponding to the difference if the difference is a positive number and enlarging the base data corresponding to the difference if the difference is a negative number.

Advantageously, the calculating total task amount and manpower quantity required to be input of the specified service line within a specified period of time according to the predication values includes: summing up the predication values of the specified service lines within the specified period of time to obtain the total task amounts of the specified service lines within the specified period of time; acquiring a call date duration and attendance data of a plurality of agents, calculating working efficiency of each agent person according to the call date duration and the attendance data, and calculating an average value of the working efficiencies to obtain a conversion rate; and acquiring a standard working duration, calculating an average working duration according to the standard working duration and the conversion rate, and calculating a quotient between the total task amount and the average working duration to serve as a manpower quantity required to be input.

Embodiments of the present disclosure also provide a service line-based predication device, which comprises: a first acquiring module for, when service, predication is performed in a specified service line, acquiring a predication model corresponding to this specified service, line, and input dimensions and output dimensions of this predication; a second acquiring module for acquiring predication data satisfying the input dimensions from a data warehouse; an analysis module for performing trend analysis on the predication data adopting Monte Carlo simulation and geometric Brownian motion through the predication model to obtain predication values of the output dimensions; a calculation module for calculating total task amount and manpower quantity required to be input of the specified service line within a specified period of time according to the predication values; wherein, the predication model is divided into an incoming call predication model and a calling predication model according to service types, and the data warehouse is composed of call data and dialing list data within preset historical time after cleaning.

Advantageously, the device further includes: a third acquiring module for acquiring marketing activities and emergent events within the preset historical time after the prediction vales of the output dimensions are obtained, and determining dates of a week after the marketing activities and the emergent events occur; and a smoothing processing module for performing smoothing processing on the predication values of the output dimensions according to the dates of a week of the marketing activities and the emergent events to eliminate the interference of the marketing activities and the emergent events on the predication values.

Advantageously, the smoothing processing module includes: a screening unit for traversing all the output dimensions, and screening predication values having the same dates of a week from the predication values of the output dimensions to serve as base data; a statistical processing unit for calculating an average value and a standard deviation of the base data; a comparison unit for calculating a difference between each base data and the average value, and comparing an absolute value of the difference with the standard deviation; and a smoothing processing unit for, when the absolute value of the difference is greater than the standard deviation, reducing the base data corresponding to the difference if the difference is a positive number and enlarging the base data corresponding to the difference if the difference is a negative number.

Advantageously, the calculation module includes: a total amount calculation unit for summing up the predication values of the specified service lines within the specified period of time to obtain the total task amounts of the specified services line within the specified period of time; a conversion rate calculation unit for acquiring a call date duration and attendance data of a plurality of agents, calculating working efficiency of each agent person according to the call date duration and the attendance data, and calculating an average value of the working efficiencies to obtain a conversion rate: and a manpower calculation unit for acquiring a standard working duration, calculating an average working duration according to the standard working duration and the conversion rate, and calculating a quotient between the total task amount and the average working duration to serve as a manpower quantity required to be input.

Embodiments of the present disclosure also provide a computer readable storage medium on, which, a computer readable instruction is stored. When the computer readable instruction is executed by a processor, the following steps are realized: when service predication is performed on a specified service line, acquiring a predication model corresponding to this specified service line, and input dimensions and output dimensions of this prediction: acquiring predication data satisfying the input, dimensions from a data warehouse; performing trend analysis on the predication data adopting Monte Carlo simulation and geometric Brownian motion through the predication model to obtain predication values of the output dimensions; and calculating total task amount and manpower quantity required to be input of the specified service line within a specified period of time according to the predication values; wherein, the predication model is divided into an incoming call predication model and a calling predication model according to service types, and the data warehouse is composed of call data and dialing list data within preset historical time after cleaning.

Embodiments of the present disclosure also provide a terminal, which comprises a memory, a processor and a computer readable instruction stored on the memory and executed on the processor. When the processor executes the computer readable instruction, the following steps are realized: when service predication is performed on a specified service line, acquiring a predication model corresponding to this specified service line, and input dimensions and output dimensions of this prediction; acquiring predication data satisfying the input dimensions from a data warehouse; performing trend analysis on the predication data adopting Monte Carlo simulation and geometric Brownian motion through the predication model to obtain predication values of the output dimensions; and calculating total task amount and manpower quantity required to be input of the specified service line within a specified period of time according to the predication values; wherein, the predication model is divided into an incoming call predication model and a calling predication model according to service types, and the data warehouse is composed of call data and dialing list data within preset historical time after cleaning.

Compared with the prior art, in embodiments of the present disclosure, different predication models are constructed according to different service types, including an incoming call predication model and a calling predication model. When service predication is performed on a specified service line, a predication model corresponding to this specified service line and input dimensions and output dimensions of this predication are acquired; then predication data satisfying the input dimensions is acquired from a data warehouse; trend analysis is performed on the predication data adopting Monte Carlo simulation and geometric Brownian motion through the predication model to obtain predication values of the output dimensions; total task amount and manpower quantity required to be input of the specified service line are calculated within a specified period of time according to the predication values, thereby realizing that different predication modes, are adopted aiming, at different service scenes and improving the predication accuracy of different service lines.

### DESCRIPTION OF THE DRAWINGS

In order to make the technical solutions in the disclosure or in the prior art described more clearly, the drawings associated to the description of the embodiments or the prior art will be illustrated concisely hereinafter. Obviously, the drawings described below are only some embodiments according to the disclosure. Numerous drawings therein will be apparent to one of ordinary skill in the art based on the drawings described in the disclosure without creative efforts.

FIG. 1 is a first flowchart of a service line-based prediction method according to embodiments of the present disclosure;

FIG. 2 is a flowchart of a step S104 in FIG. 1 according to embodiments of the present disclosure;

FIG. 3 is a second flowchart of a service line-based prediction method according to embodiments of the present disclosure;

FIG. 4 is a flowchart of a step S305 in FIG. 3 according to embodiments of the present disclosure;

FIG. 5 is a structural diagram of a service line-based prediction device according to embodiments of the present disclosure; and

FIG. 6 is a schematic diagram of a terminal according to embodiments of the present disclosure.

### DETAILED DESCRIPTION OF PREFERRED EMBODIMENTS

In order to make the objects, technical solution and advantages of the present disclosure more clear, the present disclosure will be further described in detail with reference to the accompanying drawings and embodiments below. It should be understood that embodiments described here are only for explaining the present disclosure and the disclosure, however, should not be constructed as limited to the embodiment as set, forth herein.

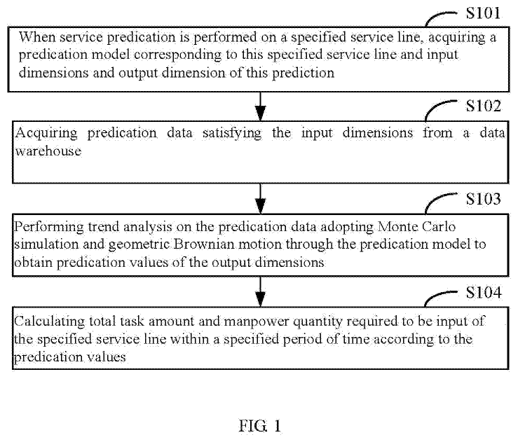

In embodiments of the present disclosure, prediction of service lines is predication of workloads and manpower of the service lines to prepare for scheduling prediction. Optionally, the service line-based prediction method described in embodiments of the present disclosure may be applied to a terminal, and the terminal includes but not is limited to a computer, a server and a laptop. FIG. 1 shows a first procedure of a service line-based prediction method according to embodiments of the present disclosure.

Referring to FIG. 1, the service line-based prediction method includes:

In step S101, when service predication is performed on a specified service line, acquiring a predication model corresponding to this specified service line, and input dimensions and output dimensions of this prediction.

In this step, according to embodiments of the present disclosure, corresponding prediction models are established according to different service types, including an incoming call prediction, model and a calling prediction model. The incoming call prediction model is used for prediction of total task amounts and manpower arrangement on services of incoming call types, and the calling prediction model is used for prediction of total task amounts and manpower arrangement on services of calling types. In embodiments of the present disclosure, the incoming call prediction model and the calling prediction model both use Monte Carlo simulation and geometric Brownian motion as random models and extract call data and dialing list data within preset historical time from a service database for processing and analysis and then guide the above data into an analysis database to construct data warehouses corresponding to the incoming call prediction model and the calling prediction model. Optionally, the preset historical time is preferably within the latest one year.

In embodiments of the present disclosure, corresponding input dimensions and output dimensions are respectively configured for the incoming call prediction model and the calling prediction model so as to be selected by a user. The input dimensions are types of parameters input to the incoming call model or the calling prediction model. The output models, are types of parameters output after prediction data corresponding to the input, dimensions are processed by the incoming call prediction model or the calling prediction model.

For the incoming call prediction model, its input dimensions include but are not limited to a call duration, an agent work utilization rate, a call loss rate, a satisfaction degree and an agent skill level; and the output dimensions include but are not limited to a call duration, call times, an agent utilization rate and a call loss rate.

For the calling prediction model, its output dimensions include but are not limited to issued list amount, a call completion rate, an average call duration, an agent work utilization rate and an agent skill level; and the output dimensions include but are not limited to a list amount, dialing times, a dialing duration, a call completion rate and an agent utilization rate.

Compared, with the uniformly adopted prediction modes for prediction in the prior art, embodiments of the present disclosure achieve adoption of different prediction modes aiming at different service scenes and selection of more adaptive input dimensions and output dimensions through establishment of different prediction models and configuration of different types of input dimensions and output dimensions for different prediction models, so as to benefit improvement of prediction accuracy of different service lines and facilitate a user to select and regulate a prediction model corresponding to a specified service line and input parameters and output parameters thereof.

Before the service line is predicted, the user may choose a prediction model corresponding to the service line on a terminal in advance and select input dimensions and output dimensions for prediction. When receiving a scheduling prediction instruction to perform workload, prediction on the specified service line, the terminal acquires the corresponding prediction model according to the current specified service line, and the input dimensions and the output dimensions of this prediction.

In step S102, acquiring predication data satisfying the input dimensions from a data warehouse.

As described above, the prediction model creates a data warehouse, depending on call data and dialing list data within preset historical time after cleaning. Thus, in embodiments of the present disclosure, when prediction is performed, prediction data are screened from the data warehouse based on the specified input dimensions.

Exemplarily, for the incoming call prediction model, its input dimensions include but are not limited to a call duration, an agent work utilization rate, a call loss rate, a satisfaction degree and an agent skill level. If the selected input dimensions for prediction include three parameters such as call duration, agent work utilization rate and call loss, rate, data satisfying the above three dimensions are screened from the data warehouse to serve as prediction data.

In step S103, performing trend analysis on the predication data adopting Monte Carlo simulation and geometric Brownian motion through the predication model to obtain predication values of the output dimensions.

Exemplarily, when trend analysis is performed on the predication data adopting Monte Carlo simulation and geometric Brownian motion, a proper priori distribution, model is selected first, then random sampling is rapidly, sufficiently and largely performed utilizing give rules based on the above, prediction data, mathematical statistics and statistical treatment are performed on the sampled data, then a probability distribution curve and a cumulative probability curve, which are generally normally distributed probability cumulative S curves, are generated according to the above statistical treatment result, trend analysis is performed according to the cumulative probability curves to obtain prediction values, and finally, the prediction values satisfying the selected output dimensions are screened. Exemplarily, if the selected output dimension is the call duration, the prediction value of this call duration is obtained after passing through the prediction model.

In step S104, calculating total task amount and manpower quantity required to be input of the specified service line within a specified period of time according to the predication values.

After the prediction value satisfying the output dimension is obtained, workload of the service line within the specified period of time is calculated based on the prediction value. The specified period of time is less than time spans of call data and dialing list data in the data warehouse.

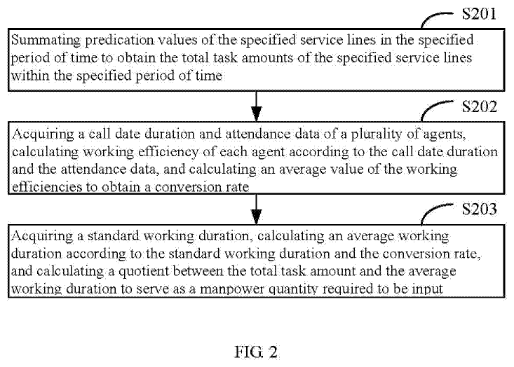

Optionally, FIG. 2 shows a specific, procedure of step S104 in FIG. 1 according to embodiments of the present disclosure. Referring to FIG. 2, the step S104 includes:

In step S201, summing up the predication values of the specified service lines within the specified period of time to obtain the total task amounts of the specified service lines within the specified period of time.

In this step, according to embodiments of the present disclosure, firstly, the total task amounts of the specified service lines within the specified period of time are calculated according to the prediction values obtained via the prediction model. Exemplarily, for agents, the total task amount is represented by time (minute). It is, assumed that this prediction is an incoming call prediction model, the selected output dimension is the call duration, the specified period of time is from June 25 to June 29, five days in total, the sum of prediction values of five days from June 25 to June 29 is calculated after the prediction value of the call duration is obtained, so as to obtain the total task amount of the specified service line within the specified period of time.

In step S202, acquiring a call date duration and, attendance data of a plurality a agents, calculating working efficiency of each agent according to the call date duration and the attendance data, and calculating an average value of the working efficiency to obtain a conversion rate.

In this step, although a standard work duration is regulated, each agent cannot, ensure 100% sufficient utilization of this standard work duration at work, and situations such as conference, rest, leaving and vacation occur within the working time. In view of this, embodiments of the present disclosure acquire call date durations and attendance data of a plurality of agents; this call date duration is a total duration after all the calls of a single agent are added within one day. Then, working efficiency of each agent is calculated according to the call date duration and the attendance data, and the average value of the working efficiencies is calculated to obtain the conversion rate. The conversion rate is an average probability of efficiently utilized standard work durations.

In step S203, acquiring a standard working duration, calculating an average working duration according to the standard working duration and the conversion rate, and calculating a quotient, between the total task amount and the average working duration to serve as a manpower quantity required to be input.

After the conversion rate is obtained, a product of the standard working duration and the conversion rate is calculated to obtain an average working duration of the agent. This average working duration reflects a daily working duration of a single agent. Finally, a quotient between the total task amount and the average working duration is calculated. In embodiments of, the present disclosure, the quotient value is used as manpower quantity required to be input, so as to achieve manpower prediction based on service lines, and subsequent scheduling is performed according to the manpower quantity. In embodiment of the present disclosure, the average working duration is calculated according to actual call day duration and attendance data, thereby efficiently improving the adaptive degree of manpower prediction.

Further, situations such as marketing activity, system abnormity and equipment malfunction may result in great fluctuations of history data, these fluctuations may influence prediction values of scheduling, and thus, embodiments of the present disclosure also include performing smoothing processing on prediction values obtained through the prediction model.

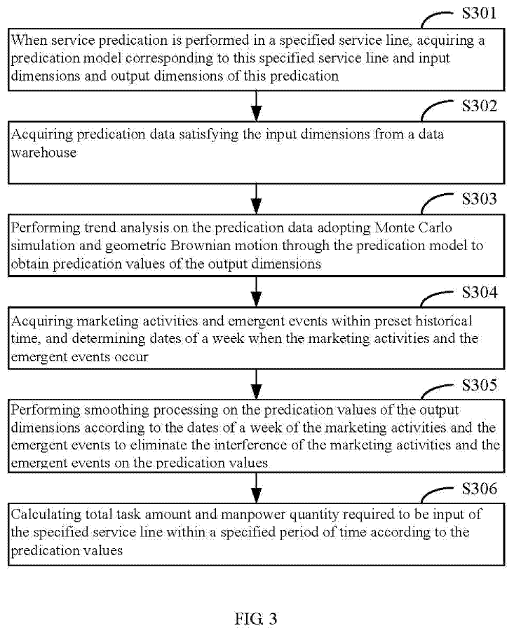

Based on a first procedure of a service line-based prediction method described in the above embodiment of FIG. 1, a second procedure of a service, line-based prediction method described in the embodiments of the present disclosure is provided. Referring to FIG. 3, the service line-based prediction method includes:

In step S301-step S303, step S301-step S303 are the same as the step S101-step S103 described in the embodiment of FIG. 1, which specifically refer description of the above embodiments, and are not repeatedly described here.

After the prediction values of the output dimensions are obtained, the prediction method further includes:

In step S304, acquiring, marketing activities and emergent events within the preset historical time, and determining dates of a week when the marketing activities and the emergent events occur.

In this step, the emergent events include but are, not limited to system abnormity, equipment malfunction and other situations. The preset historical time is time span of call data and dialing list data in the data warehouse. Embodiments of the present disclosure acquire occurrence dates of marketing activities and emergent events within this time span range. The occurrence dates are dates of a week, the dates of a week are dates in seven days of a week, for example, Monday, Tuesday, Wednesday, Thursday, Friday, Saturday and Sunday.

In Step S305, performing smoothing processing on the predication values, of the output dimensions according to the dates of a week of the marketing activities and the emergent events to eliminate the interference of the marketing activities and the emergent events on the predication values.

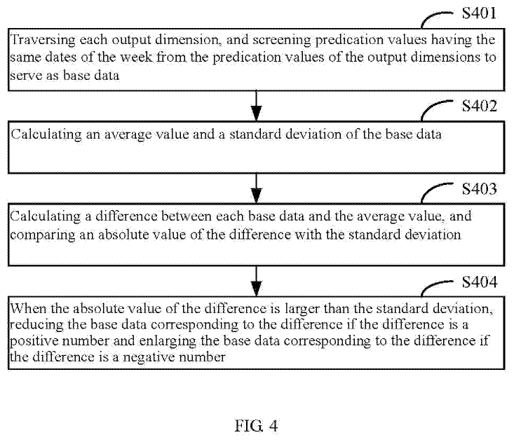

Optionally, FIG. 4 shows a specific procedure of step S305 in the second procedure of a service line-based prediction method according to embodiments of the present disclosure. Referring to FIG. 4, the step S305 includes:

In step S401, traversing all the output dimensions, and screening predication, values having the same dates of a week from the predication values of the output dimensions to serve as base data.

For each output dimension, based on the dates of a week, prediction values having the same dates of a week are screened from the prediction values of the output dimensions. Exemplarily, if the date of a week of marketing activities is Tuesday, prediction value of the output dimension on each Tuesday is screened, and the screened prediction values serve as base data.

In step S402, calculating an average value and a standard deviation of the base data.

In this step, the standard deviation of the base data is a judgment criterion for whether smoothing processing is performed on the base data.

In step S403, calculating a difference between each base data and the average value, and comparing an absolute value of the difference with the standard deviation.

As described above, after the average value and, the standard deviation of the prediction values of the output dimension on each Tuesday are obtained, a difference between the prediction value of the output dimension on each Tuesday and the average value is calculated, and an absolute value of the difference is compared with the standard deviation calculated in step S402 to determine whether the prediction value is corrected.

In step S404, when the absolute value of the difference is greater than the standard deviation, reducing the base data corresponding to the difference if the difference is a positive number and enlarging the base data corresponding to the difference if the difference is a negative number.

In this step, embodiments of the present disclosure use a prediction value whose error is not within the standard deviation range as abnormal data. Namely, the prediction value is corrected when the absolute value of the difference is greater than the standard deviation, including: judging whether the difference is positive or negative, if the difference being a positive number indicates that the base data corresponding to the difference is large, corresponding base data is reduced, and if the difference being a negative number indicates that the base data corresponding to the difference is small, corresponding base data is enlarged, thereby completing smoothing processing on the prediction value of the output dimension. In this step, base data during marketing activity is obviously higher than or greater than the average value in general, and thus, a difference between the base data during marketing activity and the average value is a positive number and the difference is greater than the standard deviation, at this moment, the base data during marketing activity is reduced so that the base data during marketing activity converges at a rule in the preset historical time, so as to eliminate fluctuation interference of the marketing activity on the prediction value. The base data during occurrence of the emergent event is obviously lower than or smaller than the average value in general, and thus, a difference between the base data during occurrence of the emergent event and the average value is a negative number and the absolute value of the difference is greater than the standard deviation, at this moment, the base data during occurrence of the emergent event is enlarged so that the base data during occurrence of the emergent, event converges at a rule in the preset historical time, so as to eliminate fluctuation interference of the emergent event on the prediction value.

In step S306, calculating total task amount and manpower quantity required to be input of the specified service line within a specified, period of time according to the predication values.

Because the fluctuation interference of the marketing activities and the emergent events is eliminated by the prediction values, the total, task amounts and the manpower of the specified service lines are predicted based on the prediction values subjected to smoothing processing, thereby effectively improving the accuracy and adaptive degree of the prediction result.

It should be understood that in the above embodiments, the sequence numbers of various steps do not mean an execution sequence, the execution sequence of various steps should be determined based on functions and internal, logic thereof but does not define the execution process of the embodiment of the present disclosure.

It is noted that those of ordinary skill in the art can understand that all or partial steps realizing the above embodiments can be completed by hardware, or by a computer readable instruction to instruct relevant instructions, the computer readable instruction may be stored in a computer readable storage medium, and the storage medium may be read-only memory, a disk or an optical disc, etc.

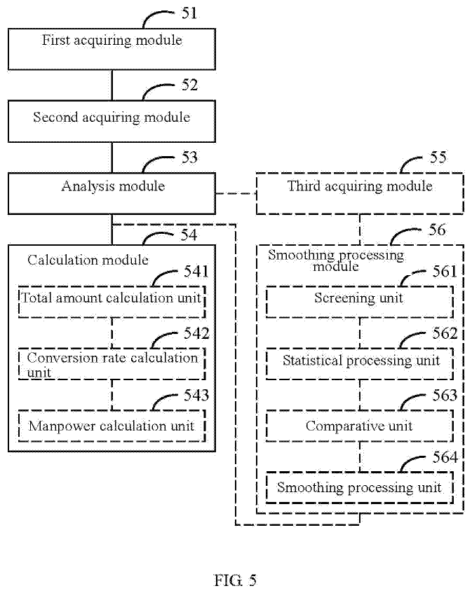

FIG. 5 shows a structural diagram of a service line-based prediction device according to embodiments of the present disclosure. For convenient explanation, parts related to embodiments of the present disclosure are only illustrated.

In embodiments of the present disclosure, the service line-based prediction device is used for achieving the service line-based prediction method, described in embodiments of FIG. 1-FIG. 4, and may be a software unit, a hardware unit or a software/hardware combined unit which are built in a terminal. The terminal includes but is not limited to a computer, a server and a laptop.

Referring to FIG. 5, the service line-based prediction device includes: a first acquiring module 51 for, when service predication is performed in a specified service line, acquiring a predication model corresponding to a specified service line, and input dimensions and output dimensions of this predication; a second acquiring module 52 for acquiring predication data satisfying the input dimensions from a data warehouse; an analysis module 53 for performing trend analysis on the predication data adopting Monte Carlo simulation and geometric Brownian motion through the predication model to obtain predication values of the output dimensions; a calculation module 54 for calculating total task amount and manpower quantity required to be input of the specified service line within a specified period of time according to the predication values; wherein, the predication model is divided into an incoming call predication model and a calling predication model according to service types, the incoming call prediction model is used for prediction of total task, amount and manpower arrangement of services of incoming call types, and the calling prediction model is used for prediction of total task amount and manpower arrangement of services of calling types. The incoming call prediction model and the calling prediction model both use Monte Carlo simulation and geometric Brownian motion as random models. The data warehouse is composed of call data and dialing list data within preset historical time after cleaning.

In embodiments of the present disclosure, corresponding input dimensions and output dimensions are configured for the incoming call prediction model and the calling prediction model to be selected by the user, wherein, the input dimensions are types of parameters input to the incoming call prediction model or the calling prediction model. The output dimensions are types of parameters output after prediction data corresponding to the input dimensions are processed via the incoming call prediction model or the calling prediction model.

For the incoming call prediction model, its input dimensions, include but are not limited to a call duration, an agent work utilization rate, a call loss rate, a satisfaction degree and an agent skill level; the output dimensions include but are not limited to a list amount, dialing times, a dialing duration, a call completion rate, a call duration and an agent utilization rate.

Compared with the uniformly adopted prediction modes in the prior art, embodiments of the present disclosure achieve adoption of different prediction modes aiming at different service scenes and selection of more adaptive input dimensions and output dimensions by establishing different prediction models and configuring different types of input dimensions and output dimensions for different prediction models, thereby benefiting improvement of accuracy of predicting different service lines, and facilitating a user to select and regulate prediction models corresponding to the specified service lines and input parameters and, output parameters thereof.

Further, the calculation module 54 includes: a total amount calculation unit 541 for summing up predication values of the specified service lines within the specified period of time to obtain the total task amounts of the specified service lines within the specified period of time; a conversion rate calculation unit 542 for acquiring a call date duration and attendance data of a plurality of agents, calculating working efficiency of each agent person according to the call date duration and the attendance data, and calculating an average value of the working efficiencies to obtain conversion rates; a manpower calculation unit 543 for acquiring a standard working duration, calculating an average working duration according to the standard working duration and the conversion rate, and calculating a quotient between the total task amount and the average working duration to serve as a manpower quantity required to, be input.

In embodiments of the present disclosure, an average work date duration is calculated according to actual call date duration and attendance data, thereby effectively improving the adaptive degree of manpower prediction.

Further, situations such as marketing activity, system abnormity and equipment malfunction may result in great fluctuations of, history data, these fluctuations may influence prediction values of scheduling. In view of this, the device also includes: a third acquiring module 55 for acquiring marketing activities and emergent events within the preset historical time after the prediction values of the output dimensions are obtained, and determining dates of a week after the marketing activities and the emergent events occur; a smoothing processing module 56 for performing smoothing processing on the predication values of the output dimensions according to the dates of a week of the marketing, activities and the emergent events to eliminate the interference of the marketing activities and the emergent events on the predication values.

Further, the smoothing processing module 56 includes: a screening unit 561 for traversing all the output dimensions, and screening predication values having the same dates of a week from the predication values of the output dimensions to serve as base data; a statistical processing unit 562 for calculating an average value and a standard deviation of the base data; a comparison unit 563 for calculating a difference between each base data and the average value, and comparing an absolute value of the difference with the standard deviation; a smoothing processing unit 564 for, when the absolute value of the difference is greater than the standard deviation, reducing the base data corresponding to the difference if the difference is a positive number and enlarging the base data corresponding to the difference if the difference is a negative number.

In embodiments of the present disclosure, base data is acquired in dates of a week so as to expand a coverage range of sample data, the prediction values subjected to smoothing processing may effectively remove fluctuation interference of marketing activities and emergency events. The total task amount and the manpower of the specified service lines are predicted based on the prediction values subjected to smoothing processing, thereby improving the accuracy and adaptive degree of the prediction result.

It is noted that the terminal in embodiments of the present disclosure can be used for achieving all the technical solutions in the above method embodiments. Those skilled in the art can clearly understand that for convenience and concision of description, exemplification is, made only by virtue of division of above various function units and modules, in an actual application, the above functions are assigned to be completed by different function units and modules, that is, the internal structure of the device is divided into different function units or modules to complete all or partial functions of the above description. Various functions and modules may be integrated in one processing unit, or each unit individually and physically exists, or two or more than two units are integrated in one unit. In addition, specific names of various function units and modules are only for conveniently distinguishing but not limiting the protection scope of the present disclosure. The specific working process of the above units and modules may refer to corresponding processes in the foregoing method embodiments, and are not described further herein.

In the above embodiments, descriptions of various embodiments respectively have particular emphasis, parts that are not described in detail or recorded in a certain embodiment can refer to relevant descriptions of other embodiments.

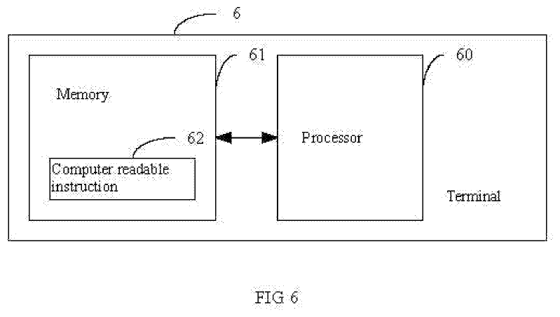

FIG. 6 is a diagram of a terminal according to an embodiment of the present disclosure. As show in FIG. 6, the terminal 6 of this embodiment includes: a processor 60, a memory 61 and a computer readable instruction 62 stored on the memory 61 and, executed on the processor 60. When the processor 60 executes the computer readable instruction 62, the following steps in the above service line-based prediction, device embodiment are realized, such as step S101-S104 as shown in FIG. 1, and step S301-S306 as shown in FIG. 3. Alternatively, when the processor 60 executes the computer readable instruction 62, functions of various modules/units in the above service line-based prediction device embodiment are realized, such as functions of modules 51-56 as shown in FIG. 5.

Exemplarily, the computer readable instruction 62 may be divided into one or more modules/units, the one or more modules/units are stored in the memory 61 and executed by the processor 60 to complete the present disclosure. The one or more modules/units may be an instruction segment of a series of computer readable instructions capable of completing specific functions, and the instruction segment is used for describing the execution process of the computer readable instruction 62 in the terminal 6. For example, the computer readable instruction 62 may be divided into a first acquiring module, a second acquiring module, an analysis module, a calculation module, and the specific functions of various modules are as follows: a first acquiring module is used for, when service predication is performed in a specified service line, acquiring a predication model corresponding to this specified service line, and input dimensions and output dimensions of this predication; a second acquiring module is used for acquiring, predication data satisfying the input dimensions from a data warehouse; an analysis module is used for performing trend analysis on the predication data adopting Monte Carlo simulation, and geometric Brownian motion through the predication model to obtain predication values of the output dimensions; a calculation module is used for calculating total task amount and manpower quantity required to be input of the specified service line within a specified period of time according to the predication values; wherein, the predication model is divided into an incoming call predication model and a calling predication model according to service types, and the data warehouse is composed of call data and dialing list data within preset historical time after cleaning.

Further, the computer readable instruction 62 may also be divided into: a third acquiring module for acquiring marketing activities and emergent events within the preset historical time after the prediction values of the output dimensions are obtained, and determining dates of a week after the marketing activities and the emergent events occur; a smoothing processing module for performing smoothing processing on the predication values of the output dimensions according to the dates of a week of the marketing activities and the emergent events to eliminate the interference of the marketing activities and the emergent events on the predication values.

Further, the smoothing processing module includes: a screening unit for traversing all the output dimensions, and screening predication values having the same dates of a week from the predication values of the output dimensions to serve as base data; a statistical processing unit for calculating an average value and a standard deviation of the base data; a comparison unit for calculating a difference between each base data and the average value, and comparing an absolute value of the difference with the standard deviation; and a smoothing processing unit for, when the absolute value of the difference is greater than the standard deviation, reducing the base data corresponding to the difference if the difference is a positive number and enlarging the base data corresponding to the difference if the difference is a negative number.

Further, the calculation module includes: a total amount calculation unit for summing up predication values of the specified service lines within the specified period of time to obtain the total task amounts of the specified service lines within the specified period of time; a conversion rate calculation unit for acquiring a call date duration and attendance data of a plurality of agents, calculating working efficiency of each agent according to the call date duration and the attendance data, and calculating an average value of the working efficiencies to obtain conversion rates; a manpower calculation unit for acquiring a standard working duration, calculating an average working duration according to the standard working duration and the conversion rate, and calculating a quotient between the total task amount and the average working duration to serve as a manpower quantity required to be input.

The terminal 6 may be a desktop, a laptop, a handheld computer, a cloud server or other computing devices. The terminal includes but is not limited to the processor 60 and the memory 61. Those skilled in the art can understand that FIG. 6 is only an example of the terminal 6 but does not limit the terminal 6 and may include more or less components as shown in the drawings, or some components or different components are combined, for example, the terminal may also include an input/output device, a network access device and a bus.

The processor 60 may be a central processing unit (CPU), may also be other general processors, a digital signal processor (DSP), an application specific integrated circuit (ASIC), a field-programmable gate array (FPGA), or other programmable logic devices, a discrete gate or transistor logic device, a discrete hardware assembly or the like. The general processor may be a microprocessor, or this processor may also be any conventional processor or the like, and the processor is a control central of the terminal, and various parts of the whole terminal are connected utilizing various interfaces and lines.

The memory 61 may be used for storing the computer readable instruction and/or module, the processor achieves, various functions of the terminal by executed or executing the computer readable instruction and/or module stored in the memory and calling data stored in the memory. The memory may mainly include a program storage area and a data storage area, wherein, the program storage area may store an operation system, an application program required by at least one function (such as a voice playing function and an image playing function) and the like; the data storage area may store data built according to the usage of the terminal and the like. In addition, the memory may include a high-speed random access memory and may also include a nonvolatile memory, such as a hard disk, an internal storage, a plug-in type hard disk, a smart media card (SMC), a secure digital (SD) card, a flash card, at least one disk memory device, a flash device or other volatile memory devices.

Those skilled in the art can appreciate that units and arithmetic steps of various examples described in combination with embodiments disclosed herein can be achieved in combination with electronic hardware, or computer software and electronic hardware. Whether these functions are executed in a hardware or software manner depends on specific application and design constraint conditions of the technical solution. Those skilled in the art may use different methods to achieve described functions as to each specific application, but this achievement should not be considered as going beyond the scope of the present disclosure.

In embodiments provided by the present disclosure, it should be understood that the disclosed device/terminal and method can be achieved in other manners. For example, the above described device/terminal equipment embodiments are only illustrative, for example, division of the module or unit is only division of logic functions, there are another division manners when in actual achievement, for example, multiple units or assemblies may be combined or may be integrated into another system, or some features may be ignored or are not executed. On the other hand, displayed or discussed mutual coupling or direct coupling or communication connection may be achieved by some interfaces, indirect coupling or communication connection of the devices or units may be of electrical, mechanical or other forms.

The units described as separation components may be or may not be physically separated, components displayed as units may be or may not be physical units, namely, may be located at one place, or may also be distributed to a plurality of grid units. Partial or all the units may be selected according to actual demand to achieve the purpose of this embodiment.

In, addition, various function units in various embodiments of the present disclosure may be integrated in one processing unit, or each unit may be individually and physically exists, or two or more than two units are integrated on one unit. The above integrated unit may be achieved both in a hardware form and a software function unit.

When being achieved in the software function unit form and sold as an independent product, the integrated module/unit may be stored in one computer readable storage medium. Based on this understanding, the present disclosure achieves all or partial procedures in the above embodiment method, which are also achieved by instructing relevant hardware from a computer readable instruction, the computer readable instruction may be stored in a computer readable storage medium, this computer readable instruction may achieve steps of the above various method embodiments when being executed by the processor, wherein, the computer readable instruction includes a computer readable instruction code which may be of a source code form, an object code form, an executable file, or some intermediate forms. The computer readable storage medium may include any solid, or device capable of carrying the computer readable instruction code, a record medium, a U disk, a mobile hardware, a diskette, an optical disk, a computer memory, a read-only memory (ROM), a random access memory (RAM), an electric carrier signal, a telecom signal and a software distribution medium. It is noted that contents contained by the computer readable storage medium may be properly increased or decreased according to laws in a judicial jurisdiction region and requirement for patent practice, for example, in some judicial jurisdiction regions, the computer readable storage medium does not include the electric carrier signal and the telecom signal according to laws and patent practice.

The above embodiments are only for illustrating the technical solutions of the present disclosure but not limiting thereto; although the present disclosure is described in detail with reference to the foregoing embodiments, those of ordinary skill in the art should understand that they may still make amendments to the technical solutions described in the foregoing various embodiments, or make equivalent substitution on partial technical features; however, these amendments or substitutions do not allow the nature of the corresponding technical solution to depart from the spirits and scopes of technical solutions of various embodiments of the present disclosure and are all included in the protection scope of the present disclosure.

1. A service line-based predication method comprising:
when service predication is performed on a specified service line, acquiring a predication model corresponding to this specified service line, and input dimensions and output dimensions of this prediction;
acquiring predication data satisfying the input dimensions from a data warehouse;
performing trend analysis on the predication data adopting Monte Carlo simulation and geometric Brownian motion through the predication model to obtain predication values of the output dimensions; and
calculating total task amount and manpower quantity required to be input of the specified service line within a specified period of time according to the predication values;
wherein, the predication model is divided into an incoming call predication model and a calling predication model according to service types, and the data warehouse is composed of call data and a dialing list data within preset historical time after cleaning.

2. The service line-based predication method according to claim 1, wherein, after the predication values of the output dimensions are obtained, the predication method further comprises:
acquiring marketing activities and emergent events within the preset historical time, and determining dates of a week when the marketing activities and the emergent events occur; and
performing smoothing processing on the predication values of the output dimensions according to the dates of a week of the marketing activities and the emergent events to eliminate the interference of the marketing activities and the emergent events on the predication values.

3. The service line-based predication method according to claim 2, wherein, the performing smoothing processing on the predication values of the output dimensions according to the dates of a week of the marketing activities and the emergent events to eliminate the interference of the marketing activities and the emergent events on the predication values comprises:
traversing all the output dimensions, and screening predication values having the same dates of a week from the predication values of the output dimensions to serve as base data;
calculating an average value and a standard deviation of the base data;
calculating a difference between each base data and the average value, and comparing an absolute value of the difference with the standard deviation; and
when the absolute value of the difference is greater than the standard deviation, reducing the base data corresponding to the difference if the difference is a positive number and enlarging the base data corresponding to the difference if the difference is a negative number.

4. The service line-based predication method according to claim 1, wherein, the calculating total task amount and manpower quantity required to be input of the specified service line within a specified period of time according to the predication values comprises:
summing up the predication values of the specified service lines within the specified period of time to obtain the total task amounts of the specified service lines within the specified period of time;
acquiring a call date duration and attendance data of a plurality of agents, calculating working efficiency of each agent according to the call date duration and the attendance data, and calculating an average value of the working efficiencies to obtain a conversion rate; and
acquiring a standard working duration, calculating an average working duration according to the standard working duration and the conversion rate, and calculating a quotient between the total task amount and the average working duration to serve as a manpower quantity required to be input.

5. The service line-based predication method according to claim 2 or 3, wherein, the calculating total task amount and manpower quantity required to be input of the specified service line within a specified period of time according to the predication values comprises:
summing up predication values of the specified service lines within the specified period of time to obtain the total task amounts of the specified service lines within the specified period of time;
acquiring a call date duration and attendance data of a plurality of agents, calculating working efficiency of each agent according to the call date duration and the attendance data, and calculating an average value of the working efficiencies to obtain a conversion rate; and
acquiring a standard working duration, calculating an average working duration according to the standard working duration and the conversion rate, and calculating a quotient between the total task amount and the average working duration to serve as a manpower quantity required to be input.

6. A service line-based predication device, comprising:
a first acquiring module for, when service predication is performed in a specified service line, acquiring a predication model corresponding to this specified service line, and input dimensions and output dimensions of this predication;
a second acquiring module for acquiring predication data satisfying the input dimensions from a data warehouse;
an analysis module for performing trend analysis on the predication data adopting Monte Carlo simulation and geometric Brownian motion through the predication model to obtain predication values of the output dimensions; and
a calculation module for calculating total task amount and manpower quantity required to be input of the specified service line within a specified period of time according to the predication values;
wherein, the predication model is divided into an incoming call predication model and a calling predication model according to service types, and the data warehouse is composed of call data and dialing list data within preset historical time after cleaning.

7. The service line-based predication device according to claim 6, further comprising:
a third acquiring module for acquiring marketing activities and emergent events within the preset historical time after the prediction values of the output dimensions are obtained, and determining dates of a week when the marketing activities and the emergent events occur; and
a smoothing processing module for performing smoothing processing on the predication values of the output dimensions according to the dates of a week of the marketing activities and the emergent events to eliminate the interference of the marketing activities and the emergent events on the predication values.

8. The service line-based predication device according to claim 7, wherein, the smoothing processing module comprises:
a screening unit for traversing all the output dimensions, and screening predication values having the same dates of a week from the predication values of the output dimensions to serve as base data;
a statistical processing unit for calculating an average value and a standard deviation of the base data;
a comparison unit for calculating a difference between each base data and the average value, and comparing an absolute value of the difference with the standard deviation; and
a smoothing processing unit for, when the absolute value of the difference is greater than the standard deviation, reducing the base data corresponding to the difference if the difference is a positive number and enlarging the base data corresponding to the difference if the difference is a negative number.

9. The service line-based predication method according to claim 6, wherein, the calculation module comprises:
a total amount calculation unit for summing up the predication values of the specified service lines within the specified period of time to obtain the total task amounts of the specified service lines within the specified period of time;
a conversion rate calculation unit for acquiring a call date duration and attendance data of a plurality of agents, calculating working efficiency of each agent according to the call date duration and the attendance data, and calculating an average value of the working efficiencies to obtain a conversion rate; and
a manpower calculation unit for acquiring a standard working duration, calculating an average working duration according to the standard working duration and the conversion rate, and calculating a quotient between the total task amount and the average working duration to serve as a manpower quantity required to be input.

10. The service line-based predication method according to claim 7 or 8, wherein, the calculation module comprises:
a total amount calculation unit for summing up the predication values of the specified service lines within the specified period of time to obtain the total task amounts of the specified service lines within the specified period of time;
a conversion rate calculation unit for acquiring a call date duration and attendance data of a plurality of agents, calculating working efficiency of each agent according to the call date duration and the attendance data, and calculating an average value of the working efficiencies to obtain a conversion rate; and
a manpower calculation unit for acquiring a standard working duration, calculating an average working duration according to the standard working duration and the conversion rate, and calculating a quotient between the total task amount and the average working duration to serve as a manpower quantity required to be input.

11. A computer readable storage medium on which a computer readable instruction is stored, wherein, when the computer readable instruction is executed by a processor, the following steps are realized:
when service predication is performed on a specified service line, acquiring a predication model corresponding to this specified service line, and input dimensions and output dimensions of this prediction;
acquiring predication data satisfying the input dimensions from a data warehouse;
performing trend analysis on the predication data adopting Monte Carlo simulation and geometric Brownian motion through the predication model to obtain predication values of the output dimensions; and
calculating total task amount and manpower quantity required to be input of the specified service line within a specified period of time according to the predication values;
wherein, the predication model is divided into an incoming call predication model and a calling predication model according to service types, and the data warehouse is composed of call data and dialing list data within preset historical time after cleaning.

12. The computer readable storage medium according to claim 11, wherein, when the computer readable instruction is executed by a processor, the following steps are realized:
acquiring marketing activities and emergent events within the preset historical time, and determining dates of a week when the marketing activities and the emergent events occur; and
performing smoothing processing on the predication values of the output dimensions according to the dates of a week of the marketing activities and the emergent events to eliminate the interference of the marketing activities and the emergent events on the predication values.

13. The computer readable storage medium according to claim 12, wherein, the performing smoothing processing on the predication values of the output dimensions according to the dates of a week of the marketing activities and the emergent events to eliminate the interference of the marketing activities and the emergent events on the predication values comprises:
traversing all the output dimensions, and screening predication values having the same dates of a week from the predication values of the output dimensions to serve as base data;
calculating an average value and a standard deviation of the base data;
calculating a difference between each base data and the average value, and comparing an absolute value of the difference with the standard deviation; and
when the absolute value of the difference is greater than the standard deviation, reducing the base data corresponding to the difference if the difference is a positive number and enlarging the base data corresponding to the difference if the difference is a negative number.

14. The computer readable storage medium according to claim 11, wherein, the calculating total task amount and manpower quantity required to be input of the specified service line within a specified period of time according to the predication value comprises:
summing up predication values of the specified service lines within the specified period of time to obtain the total task amounts of the specified service lines within the specified period of time;
acquiring a call date duration and attendance data of a plurality of agents, calculating working efficiency of each agent person according to the call date duration and the attendance data, and calculating an average value of the working efficiencies to obtain a conversion rate; and
acquiring a standard working duration, calculating an average working duration according to the standard working duration and the conversion rate, and calculating a quotient between the total task amount and the average working duration to serve as a manpower quantity required to be input.

15. The computer readable storage medium according to claim 12, wherein, the calculating total task amount and manpower quantity required to be input of the specified service line within a specified period of time according to the predication value comprises:
summing up the predication values of the specified service lines within the specified period of time to obtain the total task amounts of the specified service lines within the specified period of time;
acquiring a call date duration and attendance data of a plurality of agents, calculating working efficiency of each agent person according to the call date duration and the attendance data, and calculating an average value of the working efficiencies to obtain a conversion rate; and
acquiring a standard working duration, calculating an average working duration according to the standard working duration and the conversion rate, and calculating a quotient between the total task amount and the average working duration to serve as a manpower quantity required to be input.

16-20. (canceled)
